(19) United States
(12) Patent Application Publication
(10) Pub. No.: US 2026/0009962 A1
(43) Pub. Date: Jan. 8, 2026

(54) OPTICAL APPARATUS CAPABLE OF BEING PROVIDED WITH FUNCTION FOR ADJUSTING ECCENTRICITY AND INCLINATION OF OPTICAL ELEMENT WHILE BEING COMPACT, AND ADJUSTMENT METHOD FOR OPTICAL APPARATUS

(71) Applicant: CANON KABUSHIKI KAISHA, Tokyo (JP)

(72) Inventor: YUSUKE FUJIWARA, Kanagawa (JP)

(21) Appl. No.: 19/227,939

(22) Filed: Jun. 4, 2025

(30) Foreign Application Priority Data
May 27, 2025 (JP) 2025-087898
Jul. 2, 2024 (JP) 2024-106810

(51) Int. Cl. G02B 7/00; G02B 7/02

(52) U.S. Cl. CPC G02B 7/003; G02B 7/021

(57) ABSTRACT

An optical apparatus capable of being provided with a function for adjusting the eccentricity and inclination of an optical element white being compact is provided. An optical apparatus includes a first unit including a first optical element, a second unit including a second optical element, and a holding member. A first adjustment mechanism is configured by a first engagement portion and a second engagement portion capable of sliding relatively with respect to the first engagement portion. A second adjustment mechanism is configured by a third engagement portion different from the second engagement portion, and a fourth engagement portion capable of sliding relatively with respect to the third engagement portion. Either one of an eccentricity and an inclination of the first unit with respect to an optical axis is adjusted by the first adjustment mechanism. The other of the eccentricity and the inclination is adjusted by the second adjustment mechanism.

### BACKGROUND

### Field of the Technology

The present disclosure relates to an optical apparatus and an adjustment method for the optical apparatus.

### DESCRIPTION OF THE RELATED ART

In an optical apparatus such as a digital camera or an interchangeable lens, in order to suppress degradation of image quality performance due to component shapes, insufficient precision, manufacturing errors, etc., a mechanism for improving the image quality performance by adjusting the eccentricity and inclination of an optical element relative to an optical axis has been proposed.

For example, Japanese Laid-Open Patent Publication (kokai) No. 2013-238760 has disclosed a mechanism that holds an optical element holding frame with first adjustment members and second adjustment members (such as eccentric rollers) and adjusts the eccentricity and inclination of an optical element by rotating these adjustment members in an eccentricity adjustment portion and an inclination adjustment portion.

However, the adjustment mechanism disclosed in Japanese Laid-Open Patent Publication (kokai) No. 2013-238760 requires five adjustment members to enable adjustment of the eccentricity and inclination of the optical element, which may hinder the miniaturization of the optical apparatus.

### SUMMARY

The present disclosure provides an optical apparatus capable of being provided with a function for adjusting the eccentricity and inclination of an optical element while being compact, and an adjustment method for the optical apparatus.

Accordingly, an aspect of the present disclosure provides an optical apparatus comprising a first unit that includes a first optical element, a second unit that includes a second optical element, and a holding member. A first adjustment mechanism is configured by a first engagement portion provided in the first unit and a second engagement portion provided in the second unit and capable of sliding relatively with respect to the first engagement portion. A second adjustment mechanism is configured by a third engagement portion provided in the second unit and different from the second engagement portion, and a fourth engagement portion provided in the holding member and capable of sliding relatively with respect to the third engagement portion. Either one of an eccentricity and an inclination of the first unit with respect to an optical axis is adjusted by the first adjustment mechanism. The other of the eccentricity and the inclination of the first unit with respect to the optical axis is adjusted by the second adjustment mechanism.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view of an optical apparatus.

FIG. 2 is a schematic cross-sectional view of the optical apparatus.

FIG. 3 is an exploded perspective view of a collapsible lens barrel.

FIG. 4 is an exploded perspective view of a first lens group unit.

FIG. 5 is a cross-sectional view that illustrates an optical adjustment by a first optical adjustment mechanism.

FIG. 6 is a perspective view that illustrates the optical adjustment by the first optical adjustment mechanism.

FIG. 7 is a cross-sectional view that illustrates an optical adjustment by a second optical adjustment mechanism.

FIG. 8 is a perspective view that illustrates the optical adjustment by the second optical adjustment mechanism.

FIG. 9 is an exploded perspective view of a first lens group unit.

FIG. 10 is a cross-sectional view that illustrates an optical adjustment by a first optical adjustment mechanism.

FIG. 11 is a cross-sectional view that illustrates an optical adjustment by a second optical adjustment mechanism.

### DESCRIPTION OF THE EMBODIMENTS

The present disclosure will now be described in detail below with reference to the accompanying drawings showing embodiments thereof.

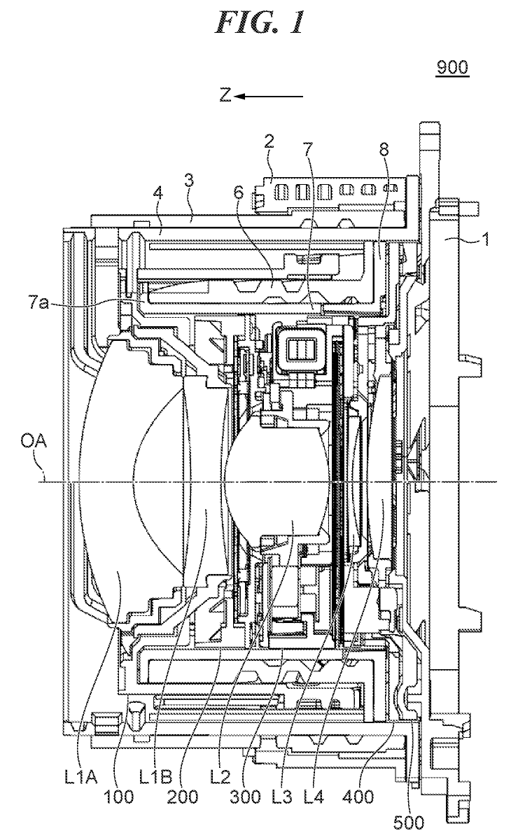

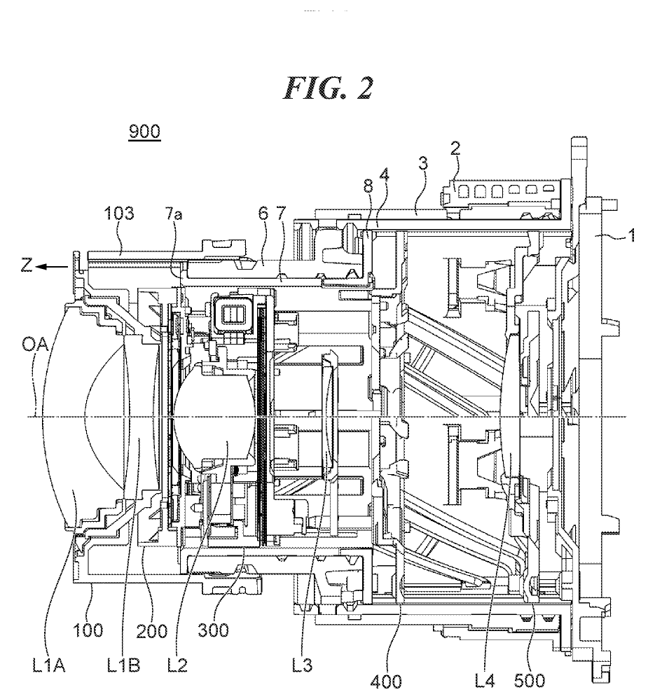

First, a first embodiment of the present disclosure will be described. FIG. 1 and FIG. 2 are schematic cross-sectional views of an optical apparatus according to the first embodiment of the present disclosure. In the first embodiment, a collapsible lens barrel 900, which is a lens barrel, is exemplified as the optical apparatus.

OA is an optical axis of a photographing optical system. In the following description, a direction in which the optical axis OA extends will be referred to as an optical axis direction, and a rotation direction around the optical axis OA will be referred to as a circumferential direction. With respect to the Z direction parallel to the optical axis direction, the subject side is defined as the +Z side.

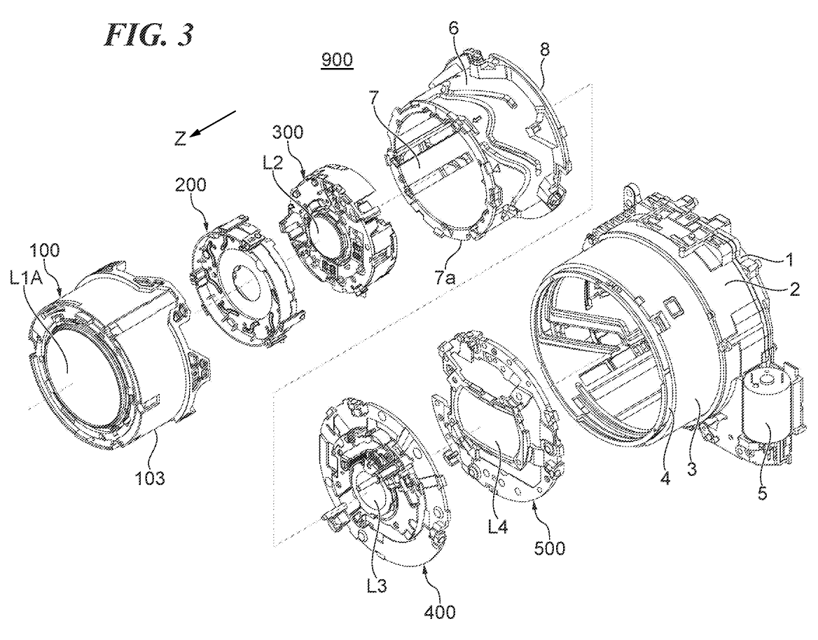

FIG. 3 is an exploded perspective view of the collapsible lens barrel 900. In FIG. 1 and FIG. 2, a cross section including the optical axis OA is shown. FIG. 1 shows the collapsible lens barrel 900 in a collapsed state, and FIG. 2 shows the collapsible lens barrel 900 in a telephoto end state. FIGS. 1 to 3 show the collapsible lens barrel 900 in a semi-finished state after optical adjustment, and the collapsible lens barrel 900 is completed by attaching a lens barrier unit (not shown) and a cover cylinder 2.

The collapsible lens barrel 900 includes a CMOS holder 1, the cover cylinder 2, a fixed cylinder 4, a cam cylinder 6, a rectilinear cylinder 7, and a rectilinear plate 8. The CMOS holder 1, the cover cylinder 2, and the fixed cylinder 4 constitute the main body of the collapsible lens barrel 900 and are fixed to the camera body (not shown) with screws. A drive ring 3 is fitted onto the outer periphery of the fixed cylinder 4, and the drive ring 3 is cam-engaged with the fixed cylinder 4 so that the drive ring 3 is held rotatably in the circumferential direction at a predetermined position in the optical axis direction.

A gear is press-fitted onto an output shaft of a zoom motor 5 (see FIG. 3), and a gear is formed on the outer periphery of the drive ring 3. The zoom motor 5 and the drive ring 3 are engaged with each other via a gear train. When the zoom motor 5 is driven, the drive ring 3 rotates at the predetermined position in the optical axis direction.

The rectilinear cylinder 7 and the rectilinear plate 8 are fixed integrally by a locking claw. The cam cylinder 6 is fitted onto the outer periphery of the rectilinear cylinder 7 and is sandwiched between a flange portion 7a formed on the end of the rectilinear cylinder 7 on the subject side and the rectilinear plate 8, so that the cam cylinder 6 is held rotatably in the circumferential direction while maintaining its positional relationship in the optical axis direction relative to the rectilinear cylinder 7 and the rectilinear plate 8.

A rectilinear groove for the cam cylinder 6 is provided on the inner periphery of the drive ring 3, and a cam groove for the cam cylinder 6 and a rectilinear groove for the rectilinear cylinder 7 are provided on the inner periphery of the fixed cylinder 4. When the drive ring 3 rotates at the predetermined position in the optical axis direction, the cam cylinder 6 rotates in synchronization with the drive ring 3 and moves in the optical axis direction along the cam groove provided on the fixed cylinder 4. The rectilinear cylinder 7 and the rectilinear plate 8 move linearly in the optical axis direction in synchronization with the cam cylinder 6 while being guided by the rectilinear groove provided on the fixed cylinder 4.

In addition, the collapsible lens barrel 900 includes a first lens group unit 100, an aperture unit 200, a second lens group unit 300, a third lens group unit 400, and a fourth lens group unit 500.

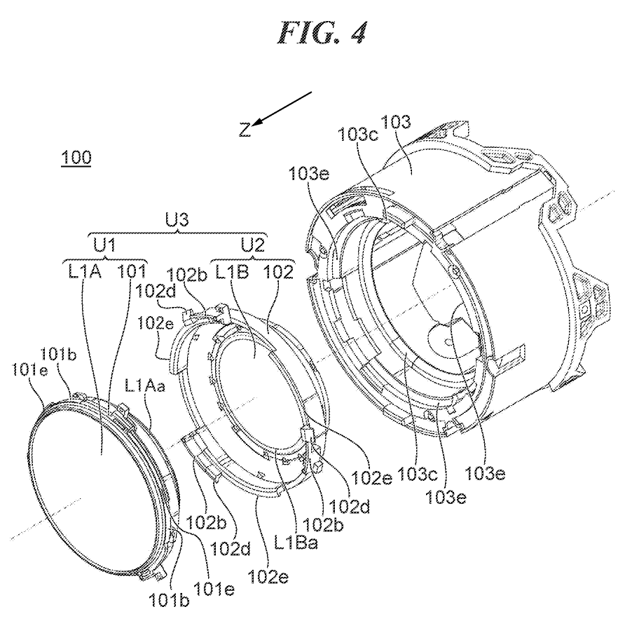

FIG. 4 is an exploded perspective view of the first lens group unit 100. The first lens group unit 100 is a lens unit that holds a 1A group lens L1A (a first optical element) and a 1B group lens L1B (a second optical element), and includes a first optical adjustment mechanism and a second optical adjustment mechanism. The first optical adjustment mechanism and the second optical adjustment mechanism will be described in detail below.

The 1A group lens L1A is held by a 1A holder 101, and the 1B group lens L1B is held by a 1B holder 102. Hereinafter, the 1A group lens L1A and the 1A holder 101 that have been integrated together will be referred to as a first unit U1, and the 1B group lens L1B and the 1B holder 102 that have been integrated together will be referred to as a second unit U2. The first unit U1 is held by the second unit U2, and the second unit U2 is held by a first lens group cylinder 103 (a holding member).

Although details are omitted, a second group lens L2 is held by the second lens group unit 300, a third group lens L3 is held by the third lens group unit 400, and a fourth group lens L4 is held by the fourth lens group unit 500, respectively. The first lens group unit 100, the aperture unit 200, and the second lens group unit 300 are cam-engaged with the cam cylinder 6 and are guided linearly by the rectilinear cylinder 7. Similarly, the third lens group unit 400 and the fourth lens group unit 500 are cam-engaged with the drive ring 3 and are guided linearly by the fixed cylinder 4. When the drive ring 3 rotates, each of the third lens group unit 400 and the fourth lens group unit 500 moves in the optical axis direction along the cam groove.

In an optical adjustment by the first optical adjustment mechanism, the eccentricity of the first unit U1 with respect to the optical axis OA is adjusted (corrected with a target of zero). In an optical adjustment by the second optical adjustment mechanism, the inclination of the first unit U1 and the second unit U2 with respect to the optical axis OA (the tilt with respect to the optical axis OA) is adjusted (corrected with a target of zero).

First, the optical adjustment by the first optical adjustment mechanism (a first adjustment) will be described with reference to FIGS. 4 to 6.

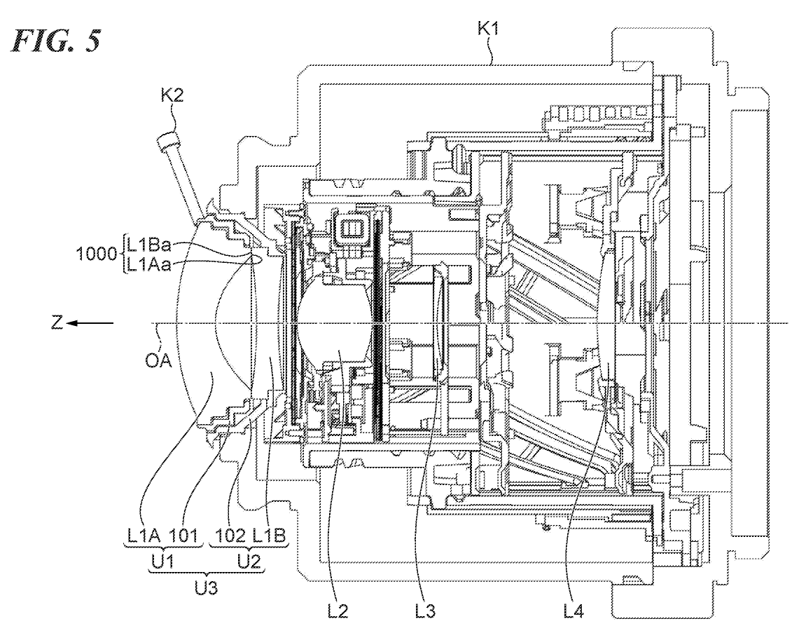

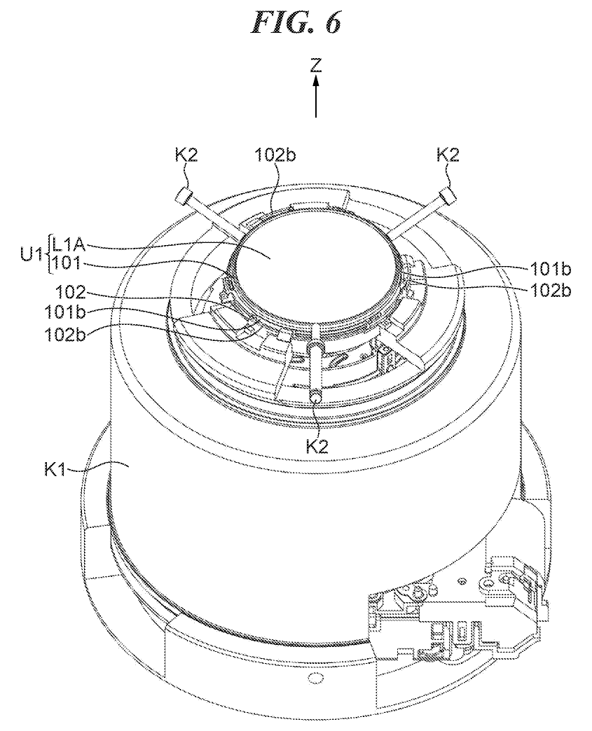

FIG. 5 is a cross-sectional view that illustrates the optical adjustment by the first optical adjustment mechanism, and FIG. 6 is a perspective view that illustrates the optical adjustment by the first optical adjustment mechanism. As will be described below, a first adjustment mechanism 1000 which is a main part of the first optical adjustment mechanism is configured by a flat surface L1Aa (a first engagement portion) of the 1A group lens L1A and a flat surface L1Ba (a second engagement portion) of the 1B group lens L1B (see FIG. 5). The flat surface L1Aa and the flat surface L1Ba are flat surfaces that are capable of sliding relative to each other and are perpendicular to the optical axis OA.

In the optical adjustment by the first optical adjustment mechanism, a worker causes a jig K1 to hold the second unit U2. At this time, the jig K1 is installed so that the +Z direction becomes upward. The second unit U2 is fitted into the jig K1 so that the movement in a direction perpendicular to the optical axis and in the circumferential direction is restricted, and the second unit U2 is statically-placed unmovably on the jig K1.

Similarly, the collapsible lens barrel 900, to which the first lens group unit 100 has not been attached, is also held by the jig K1. The collapsible lens barrel 900 is fitted into the jig K1 so that the movement in the direction perpendicular to the optical axis and in the circumferential direction is restricted by two positioning dowels, and the collapsible lens barrel 900 is statically-placed unmovably on the jig K1. Therefore, in this state, the first lens group cylinder 103 is not held by the jig K1.

In a posture where the +Z direction is upward, the first unit U1 is disposed on the second unit U2. The 1A group lens L1A has the flat surface L1Aa (a -Z side surface), which is perpendicular to the optical axis OA, on the image pickup surface side (the -Z side) (see FIG. 4 and FIG. 5). Similarly, the 1B group lens L1B has the flat surface L1Ba (a +Z side surface), which is perpendicular to the optical axis OA, on the subject side (the +Z side) (see FIG. 4 and FIG. 5).

When the first unit U1 is disposed on the second unit U2, the flat surface L1Aa and the flat surface L1Ba are brought into abutting on each other due to the weight of the first unit U1. The first unit U1 is disposed with a slight clearance between the first unit U1 and the second unit U2 in the direction perpendicular to the optical axis and in the circumferential direction, and is capable of slight movement in the direction perpendicular to the optical axis in a state where the flat surface L1Aa and the flat surface L1Ba abut on each other.

Here, in the first embodiment, the flat surface L1Aa and the flat surface L1Ba directly abut on each other. In other words, the 1A group lens L1A and the 1B group lens L1B are brought into directly abutting on each other (are brought into marginal contact with each other). By thus bringing the lenses into marginal contact with each other without using other components, it is possible to reduce the accumulation of component tolerances with respect to the air spacing, and this has the advantage of being able to guarantee the air spacing with high precision.

In order to adjust the eccentricity, the worker first moves the first unit U1 relative to the second unit U2 in the direction perpendicular to the optical axis OA. At that time, the worker causes the flat surface L1Aa and the flat surface L1Ba to slide against each other while bringing the flat surface L1Aa and the flat surface L1Ba into relatively abutting on each other. By translating the first unit U1 in the direction perpendicular to the optical axis in a state where the lenses L1B, L2, L3, and L4, which are rear group lenses, are statically placed on the jig K1, it is possible to correct the optical axis eccentricity between the 1A group lens L1A, and the rear group lenses L1B, L2, L3, and L4.

It should be noted that in the state where the lenses L1B, L2, L3, and L4, which are the rear group lenses, are held by the jig K1, respective optical axes of the lenses L1B, L2, L3, and L4 substantially coincide with the optical axis OA of the photographing optical system. Therefore, an optical axis that serves as a reference when adjusting the eccentricity and inclination of the first unit U1 and the second unit U2 (a reference optical axis) is the optical axis OA. Hereinafter, “the optical axis OA” used in the description of the optical adjustment is synonymous with the reference optical axis.

It should be noted that a thin-film light shielding sheet, which has light shielding properties, may be sandwiched between the 1A group lens L1A (the flat surface L1Aa) and the 1B group lens L1B (the flat surface L1Ba). As a result, it is possible to achieve both reduction of stray light and highly accurate guarantee of the air spacing. The worker performs the eccentricity adjustment by sandwiching and sliding the light shielding sheet between the flat surface L1Aa and the flat surface L1Ba.

Furthermore, in a state where the optical axis eccentricity has been corrected, the worker fixes the first unit U1 and the second unit U2 together. As shown in FIG. 6, the 1B holder 102 has adhesive ribs 102b on the outer periphery side of the 1A holder 101, which protrude toward the subject side in the optical axis direction. The adhesive ribs 102b and outer periphery portions 101b of the 1A holder 101 form adhesive grooves (adhesive portions). The worker is able to fill the adhesive grooves with a UV adhesive (apply or attach the UV adhesive to the adhesive grooves), thereby positioning and fixing the first unit U1 and the second unit U2. Hereinafter, a unit in which the first unit U1 and the second unit U2 are fixed integrally will be referred to as a third unit U3, and a lens in which the 1A group lens L1A and the 1B group lens L1B are fixed integrally will be referred to as a first group lens.

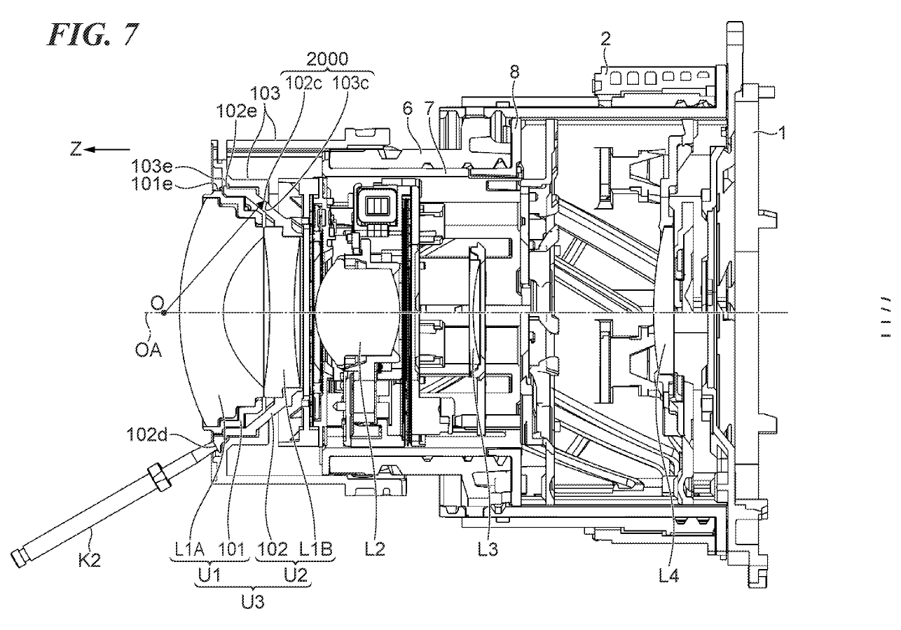

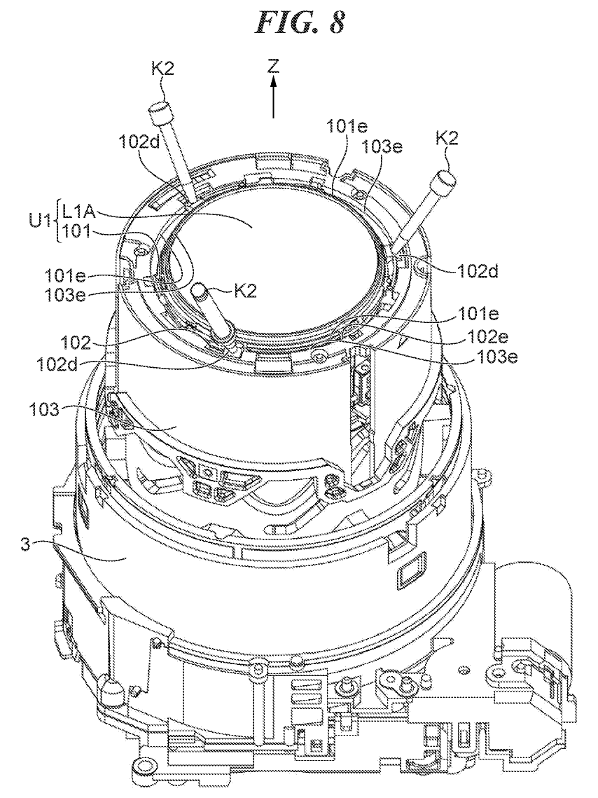

Next, the optical adjustment by the second optical adjustment mechanism (a second adjustment) will be described with reference to FIG. 4, FIG. 7, and FIG. 8.

FIG. 7 is a cross-sectional view that illustrates the optical adjustment by the second optical adjustment mechanism, and FIG. 8 is a perspective view that illustrates the optical adjustment by the second optical adjustment mechanism. As will be described below, a second adjustment mechanism 2000 which is a main part of the second optical adjustment mechanism is configured by a spherical surface 102c (a third engagement portion) of the 1B holder 102 and a spherical surface 103c (a fourth engagement portion) of the first lens group cylinder 103 (see FIG. 7). The spherical surface 102c and the spherical surface 103c are capable of sliding relative to each other.

In the optical adjustment by the second optical adjustment mechanism, the worker causes the first lens group cylinder 103 to be engaged with the cam cylinder 6 and the rectilinear cylinder 7, and disposes the third unit U3 on the first lens group cylinder 103. At this time, the third unit U3 and the collapsible lens barrel 900 that includes the first lens group cylinder 103 are installed so that the +Z direction becomes upward.

The spherical surface 102c of the 1B holder 102 is a convex curved surface that follows a spherical surface centered on a central point O, which is a point on the optical axis OA (on the optical axis), and the convex curved surface constitutes a part of the spherical surface. The spherical surface 103c of the first lens group cylinder 103 is a concave curved surface that follows the spherical surface centered on the central point O, and the concave curved surface constitutes a part of the spherical surface. For convenience, these are referred to as the spherical surfaces 102c and 103c. In other words, cross-sectional shapes of the spherical surfaces 102c and 103c in a cross section passing through the optical axis OA are arc shapes with the central point O as the center. The spherical surface 102c faces the image pickup surface side (the -Z side), and the spherical surface 103c faces the subject side (the +Z side).

When the worker disposes the third unit U3 on the first lens group cylinder 103 in the posture where the +Z direction is upward, the spherical surfaces 102c and 103c are brought into abutting on each other due to the weight of the third unit U3. The third unit U3 is disposed with a slight clearance between the third unit U3 and the first lens group cylinder 103 in the direction perpendicular to the optical axis and in the circumferential direction, and is capable of being tilted slightly with the central point O as a rotation center.

In order to adjust the inclination, first, the worker rotates the third unit U3 relative to the first lens group cylinder 103 around the central point O (rotates the third unit U3 relative to the first lens group cylinder 103 in a direction in which the angle of the optical axis of the third unit U3 itself changes with respect to the optical axis OA). At that time, the worker causes the spherical surfaces 102c and 103c to slide against each other while bringing the spherical surfaces 102c and 103c into abutting on each other.

In other words, the worker rotates the third unit U3 around the central point O in a state where the first lens group cylinder 103 is engaged with a portion of the collapsible lens barrel 900 that holds the lenses L2, L3, and L4, which are the rear group lenses. Hereinafter, the first group lens in which the 1A group lens L1A and the 1B group lens L1B are fixed integrally is simply referred to as the first group lens (L1A and L1B). As a result, it is possible to correct the inclination of the first group lens (L1A and L1B) and the rear group lenses L2, L3, and L4, that is, the optical axis tilt.

When adjusting the inclination, if the 1A holder 101 is pressed to move the third unit U3, a pressing force on the 1A holder 101 and a reaction force due to sliding friction applied to the 1B holder 102 may cause the UV adhesive on the adhesive ribs 102b and the outer periphery portions 101b to peel off. Therefore, the 1B holder 102 is provided with slope surface portions 102d against which tapering adjustment pins K2 are pressed. When adjusting the inclination, the worker is able to press the slope surface portions 102d with the adjustment pins K2 and rotate and move the 1B holder 102 in a tilt correction direction, thereby pressing the second unit U2 without going through the first unit U1. This makes it easier to maintain the adhesive state between the first unit U1 and the second unit U2. It should be noted that the adjustment pins K2 are capable of being operated (in and out) manually, but are also capable of being automatically operated by the apparatus.

Furthermore, in a state where the optical axis tilt has been corrected, the worker fixes the third unit U3 and the first lens group cylinder 103 together. The first lens group cylinder 103 has adhesive steps 103e on the outer periphery side of the 1A holder 101. The adhesive steps 103e and outer periphery portions 101e of the 1A holder 101 form adhesive grooves. The worker is able to fill the adhesive grooves with a UV adhesive (apply or attach the UV adhesive to the adhesive grooves), thereby positioning and fixing the third unit U3 and the first lens group cylinder 103.

It should be noted that outer periphery portions 102e of the 1B holder 102 may be exposed in the vicinities of the adhesive grooves to such an extent that the adhesive is capable of being applied to the outer periphery portions 102e as well. If it is not possible to apply the adhesive to the outer periphery portions 102e, the second unit U2 and the first lens group cylinder 103 will not be able to be directly adhered (bonded) to each other, and the second unit U2 and the first lens group cylinder 103 will be fixed to each other via the first unit U1. In this case, the coupling reliability of the 1B group lens L1B is low, and even a slight impact force may cause the optical axis of the 1B group lens L1B to shift. On the other hand, in the case where the adhesive is capable of being applied to the outer periphery portions 102e as well, since both of the 1A holder 101 and the 1B holder 102 are capable of be adhered (bonded) to the first lens group cylinder 103, it is possible to improve the coupling reliability of the 1B group lens L1B. It should be noted that from the viewpoint of simplifying the configuration, the adhesive grooves may be formed only by the outer periphery portions 102e and the adhesive steps 103e. Therefore, a configuration may be adopted in which at least one of the first unit U1 and the second unit U2 is fixed to the first lens group cylinder 103.

It should be noted that it is preferable that the adhesive ribs 102b, the slope surface portions 102d, and the outer periphery portions 102e of the 1B holder 102 are disposed rotationally symmetrically around the optical axis OA at equal intervals of 120 degrees. By disposing in this manner, it is possible to express rotation around two basis vectors perpendicular to the optical axis OA as the rotation center by the three adjustment pins K2.

It should be noted that in adjusting the eccentricity and inclination by the first optical adjustment mechanism and the second optical adjustment mechanism, a method for confirming a deviation from the optical axis OA does not matter. As an example, a chart and a line sensor are capable of being placed at predetermined positions on the -Z side and the +Z side of the collapsible lens barrel 900, and it is possible to confirm the deviation from the optical axis OA by comparing a contrast value outputted from the line sensor with a threshold value.

According to the first embodiment, the flat surface L1Aa of the 1A group lens L1A and the flat surface L1Ba of the 1B group lens L1B constitute the first adjustment mechanism 1000, and the spherical surface 102c of the 1B holder 102 and the spherical surface 103c of the first lens group cylinder 103 constitute the second adjustment mechanism 2000. By causing the flat surface L1Aa and the flat surface L1Ba to slide relative to each other, the eccentricity of the first unit U1 with respect to the optical axis OA is adjusted. By causing the spherical surface 102c and the spherical surface 103c to slide relative to each other, the inclination of the third unit U3 (the first unit U1 and the second unit U2) with respect to the optical axis OA is adjusted. Therefore, while being compact, it is possible to provide a function for adjusting the eccentricity and inclination of the optical elements (L1A and L1B).

Next, a second embodiment of the present disclosure will be described. In the first embodiment, the first optical adjustment mechanism has been configured to adjust the eccentricity, and the second optical adjustment mechanism has been configured to adjust the inclination. In the second embodiment of the present disclosure, the first optical adjustment mechanism is configured to adjust the inclination, and the second optical adjustment mechanism is configured to adjust the eccentricity.

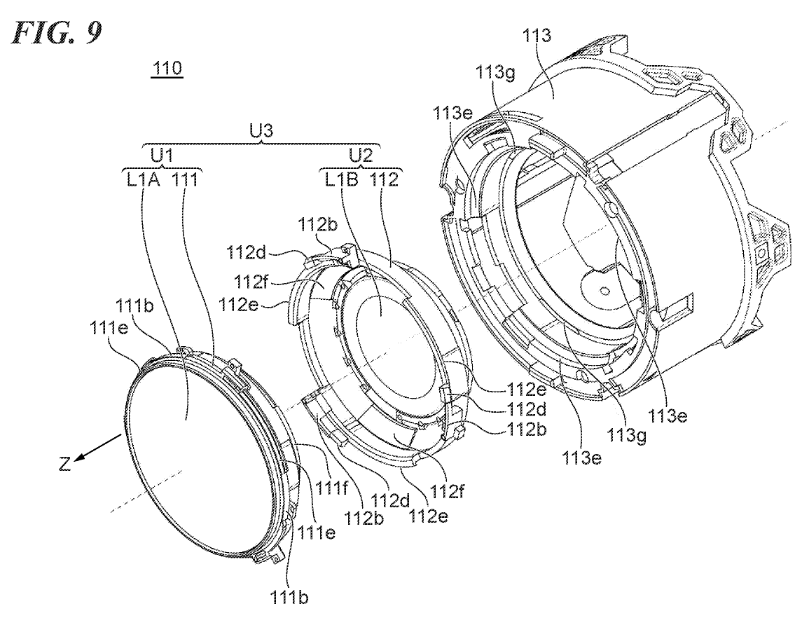

FIG. 9 is an exploded perspective view of a first lens group unit 110. The first lens group unit 110, a 1A holder 111, a 1B holder 112, and a first lens group cylinder 113 (a holding member) correspond to the first lens group unit 100, the 1A holder 101, the 1B holder 102, and the first lens group cylinder 103 in the first embodiment, respectively. In addition, adhesive ribs 112b, outer periphery portions 111b, 111e, and 112e, and adhesive steps 113e correspond to the adhesive ribs 102b, the outer periphery portions 101b, 101e, and 102e, and the adhesive steps 103e in the first embodiment, respectively.

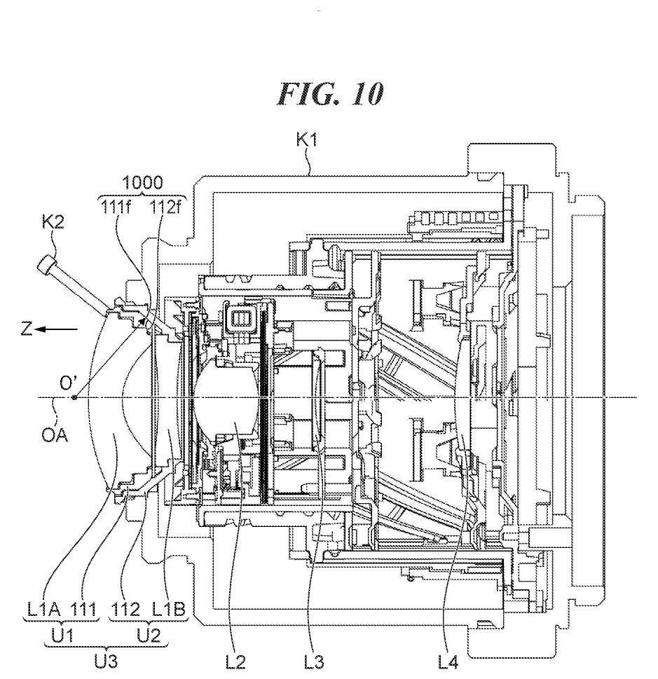

FIG. 10 corresponds to FIG. 5 and is a cross-sectional view that illustrates an optical adjustment by a first optical adjustment mechanism.

As will be described below, a first adjustment mechanism 1000 which is a main part of the first optical adjustment mechanism is configured by a spherical surface 111f (a first engagement portion) of a 1A group lens L1A and a spherical surface 112f (a second engagement portion) of a 1B group lens L1B (see FIG. 10). The spherical surface 111f and the spherical surface 112f are capable of sliding relative to each other. The geometrical features of the spherical surfaces 111f and 112f are similar to those of the spherical surfaces 102c and 103c, and can be understood by replacing the central point O with a central point O' (see FIG. 10). In other words, the spherical surface 111f is a convex curved surface that follows a spherical surface centered on the central point O', which is a point on the optical axis OA. The spherical surface 112f is a concave curved surface that follows the spherical surface centered on the central point O'.

As in the first embodiment, in the optical adjustment by the first optical adjustment mechanism (a first adjustment), the worker causes a jig K1 to hold a second unit U2 and a collapsible lens barrel 900 to which the first lens group unit 110 has not been attached. At this time, the jig K1 is installed so that the +Z direction becomes upward. In this case, restricting the movement in the direction perpendicular to the optical axis and in the circumferential direction is the same as in the first embodiment.

In a posture where the +Z direction is upward, when a first unit U1 is disposed on the second unit U2, the spherical surface 111f and the spherical surface 112f are brought into abutting on each other due to the weight of the first unit U1.

In order to adjust the eccentricity, the worker first rotates the first unit U1 relative to the second unit U2 around the central point O'. At that time, the worker causes the spherical surfaces 111f and 112f to slide against each other while bringing the spherical surfaces 111f and 112f into abutting on each other. As a result, it is possible to correct the inclination of the 1A group lens L1A and rear group lenses L1B, L2, L3, and L4, that is, the optical axis tilt.

Furthermore, in a state where the optical axis tilt has been corrected, the worker fixes the first unit U1 and the second unit U2 together. The worker is able to fill adhesive grooves (see FIG. 9), which are formed by the adhesive ribs 112b of the 1B holder 112 and the outer periphery portions 111b of the 1A holder 111, with a UV adhesive (apply or attach the UV adhesive to the adhesive grooves), thereby positioning and fixing the first unit U1 and the second unit U2.

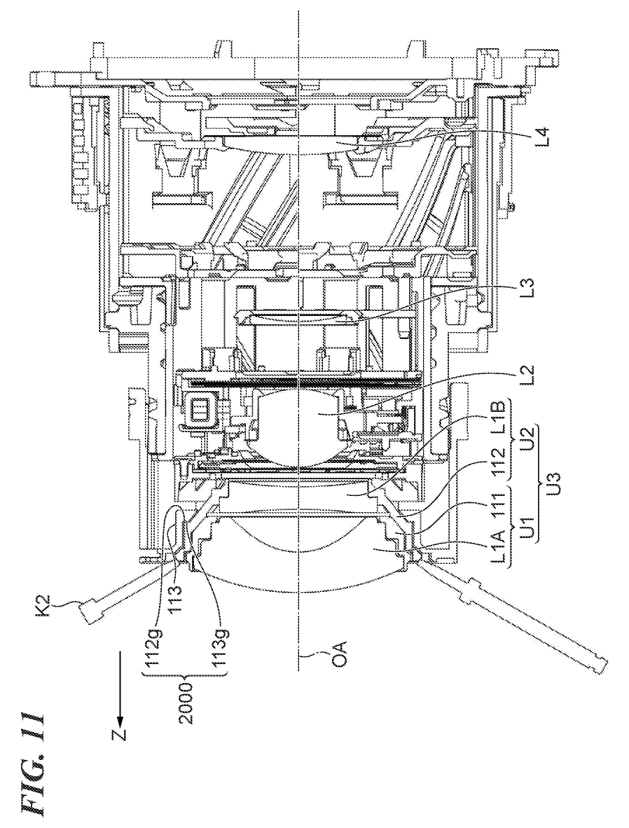

FIG. 11 corresponds to FIG. 7 and is a cross-sectional view that illustrates an optical adjustment by a second optical adjustment mechanism. As will be described below, a second adjustment mechanism 2000 which is a main part of the second optical adjustment mechanism is configured by a flat surface 112g (a third engagement portion) of the 1B holder 112 and a flat surface 113g (a fourth engagement portion) of the first lens group cylinder 113 (see FIG. 11). The flat surface 112g and the flat surface 113g are flat surfaces that are capable of sliding relative to each other and are perpendicular to the optical axis OA.

In the optical adjustment by the second optical adjustment mechanism (a second adjustment), the worker causes the first lens group cylinder 113 to be engaged with a cam cylinder 6 and a rectilinear cylinder 7, and disposes a third unit U3 on the first lens group cylinder 113. At this time, the third unit U3 and the collapsible lens barrel 900 that includes the first lens group cylinder 113 are installed so that the +Z direction becomes upward.

When the worker disposes the third unit U3 on the first lens group cylinder 113 in the posture where the +Z direction is upward, the flat surface 112g and the flat surface 113g are brought into abutting on each other due to the weight of the third unit U3.

In order to adjust the eccentricity, the worker first moves the third unit U3 relative to the first lens group cylinder 113 in the direction perpendicular to the optical axis OA. At that time, the worker causes the flat surface 112g and the flat surface 113g to slide against each other while bringing the flat surface 112g and the flat surface 113g into relatively abutting on each other. As a result, it is possible to correct the optical axis eccentricity between the first group lens (L1A and L1B), and the rear group lenses L2, L3, and L4.

Furthermore, in a state where the optical axis eccentricity has been corrected, the worker fixes the first unit U1, the second unit U2, and the first lens group cylinder 113 to one another. The worker fills adhesive grooves (see FIG. 9), which are formed by the outer periphery portions 111e of the 1A holder 111, the outer periphery portions 112e of the 1B holder 112, and the adhesive steps 113e of the first lens group cylinder 113, with a UV adhesive (apply or attach the UV adhesive to the adhesive grooves). As a result, it is possible to position and fix the first unit U1, the second unit U2, and the first lens group cylinder 113.

It should be noted that from the viewpoint of simplifying the configuration, the adhesive grooves may be formed only by the outer periphery portions 111e of the 1A holder 111 and the adhesive steps 113e of the first lens group cylinder 113. Alternatively, the adhesive grooves may be formed only by the outer periphery portions 112e of the 1B holder 112 and the adhesive steps 113e of the first lens group cylinder 113. Therefore, a configuration may be adopted in which at least one of the first unit U1 and the second unit U2 is fixed to the first lens group cylinder 113.

According to the second embodiment, the spherical surface 111f of the 1A group lens L1A and the spherical surface 112f of the 1B group lens L1B constitute the first adjustment mechanism 1000, and the flat surface 112g of the 1B holder 112 and the flat surface 113g of the first lens group cylinder 113 constitute the second adjustment mechanism 2000. By causing the spherical surface 111f and the spherical surface 112f to slide relative to each other, the inclination of the first unit U1 with respect to the optical axis OA is adjusted. By causing the flat surface 112g and the flat surface 113g to slide relative to each other, the eccentricity of the third unit U3 (the first unit U1 and the second unit U2) with respect to the optical axis OA is adjusted. Therefore, it is possible to achieve the same effect as the first embodiment in terms of providing provide a function for adjusting the eccentricity and inclination of the optical elements (L1A and L1B) while being compact.

It should be noted that in the first and second embodiments, the method for fixing each unit is not limited to providing a UV adhesive in the adhesive grooves, and other fixing methods such as fastening may be used.

It should be noted that in the first and second embodiments, the method of correcting the optical axis eccentricity and the optical axis tilt of the first group lens relative to the rear group lenses L2, L3, and L4 has been described. However, the method of correcting the optical axis eccentricity and the optical axis tilt that has been described in the present disclosure is also capable of being applied to an optical apparatus that does not have the lenses L2, L3, and L4 and in which the 1B group lens L1B is the lens closest to the image pickup surface. In this case, an image pickup device (an image sensor) is used as a reference, and the optical axis tilt of the first group lens relative to the image pickup device (the image sensor) is corrected. Thus, the optical elements to be corrected for the optical axis eccentricity and the optical axis tilt that has been described in the present disclosure are not limited to lenses, but include various kinds of elements such as apertures, optical filters, and image pickup devices (image sensors) whose eccentricity and inclination should be adjusted.

In addition, optical apparatuses, to which the technique according to the present disclosure is capable of being applied, are not limited to lens barrels, but may also be lens-integrated cameras, observation devices such as binoculars, and image projection devices such as liquid crystal projectors.

Although the present disclosure has been described above in detail based on its preferred embodiments, the present disclosure is not limited to these specific embodiments, and the present invention also includes various forms without departing from the gist of the present disclosure. Some of the embodiments described above may be combined as appropriate.

For example, a configuration may be adopted in which either one of the eccentricity and the inclination of the first unit U1 with respect to the optical axis is adjusted by the first adjustment mechanism 1000, and the other of the eccentricity and the inclination of the first unit U1 with respect to the optical axis is adjusted by the second adjustment mechanism 2000.

According to the present disclosure, it is possible to provide the function for adjusting the eccentricity and the inclination of the optical element while being compact.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-106810, filed July 2, 2024, and Japanese Patent Application No. 2025-087898, filed May 27, 2025, which are hereby incorporated by reference herein in their entirety.

What is claimed is:

1. An optical apparatus comprising:
a first unit that includes a first optical element;
a second unit that includes a second optical element; and
a holding member, and
wherein a first adjustment mechanism is configured by a first engagement portion provided in the first unit and a second engagement portion provided in the second unit and capable of sliding relatively with respect to the first engagement
portion a second adjustment mechanism is configured by a third engagement portion provided in the second unit and different from the second engagement portion, and a fourth engagement portion provided in the holding member and capable of sliding relatively with respect to the third engagement portion, either one of an eccentricity and an inclination of the first unit with respect to an optical axis is adjusted by the first adjustment mechanism, and the other of the eccentricity and the inclination of the first unit with respect to the optical axis is adjusted by the second adjustment mechanism.

2. The optical apparatus according to claim 1, wherein the eccentricity of the first unit with respect to the optical axis is adjusted by the first adjustment mechanism, and
the inclination of the first unit with respect to the optical axis is adjusted by the second adjustment mechanism.

3. The optical apparatus according to claim 2, wherein the first engagement portion and the second engagement portion are flat
surfaces perpendicular to the optical axis.

4. The optical apparatus according to claim 3, wherein the first engagement portion is a flat surface of the first optical element,
the second engagement portion is a flat surface of the second optical element, and
the first engagement portion and the second engagement portion directly abut on each other.

5. The optical apparatus according to claim 3, wherein the first engagement portion is a flat surface of the first optical element,
the second engagement portion is a flat surface of the second optical element, and
the first engagement portion and the second engagement portion abut on
each other via a light shielding sheet.

6. The optical apparatus according to claim 2, wherein the third engagement portion and the fourth engagement portion are surfaces that follow a spherical surface centered on a point on the optical axis.

7. The optical apparatus according to claim 2, wherein the second unit is provided with slope surface portions for pressing the second unit without going through the first unit in a state where the eccentricity of the first unit with respect to the optical axis has been adjusted by the first
adjustment mechanism.

8. The optical apparatus according to claim 7, wherein
the slope surface portions are disposed rotationally symmetrically around the optical axis at equal intervals of 120 degrees.

9. The optical apparatus according to claim 1, wherein
the inclination of the first unit with respect to the optical axis is adjusted by the first adjustment mechanism, and
the eccentricity of the first unit with respect to the optical axis is adjusted by the second adjustment mechanism.

10. The optical apparatus according to claim 9, wherein the first engagement portion and the second engagement portion are surfaces that follow a spherical surface centered on a point on the optical axis.

11. The optical apparatus according to claim 9, wherein
the third engagement portion and the fourth engagement portion are flat surfaces perpendicular to the optical axis.

12. The optical apparatus according to claim 1, wherein the first unit and the second unit are provided with adhesive portions for
fixing the first unit and the second unit to each other in a state where the either one of the eccentricity and the inclination of the first unit with respect to the optical axis has been adjusted by the first adjustment mechanism, to which an adhesive is adhered.

13. The optical apparatus according to claim 1, wherein the first unit and the holding member are provided with adhesive portions for fixing the first unit and the holding member to each other in a state where the
other of the eccentricity and the inclination of the first unit with respect to the optical axis has been adjusted by the second adjustment mechanism, to which an adhesive is adhered.

14. The optical apparatus according to claim 1, wherein the second unit and the holding member are provided with adhesive portions for fixing the second unit and the holding member to each other in a state where the other of the eccentricity and the inclination of the first unit with respect to the optical axis has been adjusted by the second adjustment mechanism to
which an adhesive is adhered.

15. The optical apparatus according to claim 1, wherein the first unit, the second unit, and the holding member are provided with adhesive portions for fixing the first unit, the second unit, and the holding member
to each other in a state where the other of the eccentricity and the inclination of the first unit with respect to the optical axis has been adjusted by the second adjustment mechanism to which an adhesive is adhered.

16. An adjustment method for an optical apparatus which comprises a
first unit that includes a first optical element, a second unit that includes a second optical element, and a holding member, the adjustment method comprising: performing a first adjustment that adjusts either one of an eccentricity and an inclination of the first unit with respect to an optical axis by causing a first engagement portion provided in the first unit and a second engagement portion
provided in the second unit to slide relative to each other; fixing the first unit and the second unit in a state where the first adjustment has been performed;
performing a second adjustment that adjusts the other of the eccentricity and the inclination of the first unit with respect to the optical axis by causing a third engagement portion provided in the second unit and different from the second engagement portion and a fourth engagement portion provided in the
holding member to slide relative to each other in a state where the first unit and the second unit have been fixed; and fixing at least one of the first unit and the second unit to the holding member in a state where the second adjustment has been performed.
